(19) United States
(12) Patent Application Publication
(10) Pub. No.: US 2011/0170863 A1
(43) Pub. Date: Jul. 14, 2011

(54) PHASE MODULATED SIGNAL RECEIVER

(75) Inventors: Takahiro FUJIMOTO, Kawasaki (JP); Kazuyuki Mori, Kawasaki (JP)

(73) Assignee: Fujitsu Optical Components Limited, Kawasaki (JP)

(21) Appl. No.: 13/069,797

(22) Filed: Mar. 23, 2011

Related U.S. Application Data
(63) Continuation of application No. PCT/JP2008/067498, filed on Sep. 26, 2008.

(51) Int. Cl. H04B 10/08

(52) U.S. Cl. 398/38

(57) ABSTRACT

A phase modulated signal receiver includes an operation part and a control part. An input power of a received light signal is measured based on current monitored by a monitor circuit. The operation part is configured to correct, on the basis of a ratio of the input power measured when a delay of a phase reference light output from a delay interferometer is a first delay and the input power when the delay of the phase reference light is a second delay, a value of the current monitored by the monitor circuit when the delay is the first delay to a corrected value that depends on the input power of the received light signal obtained when the delay is the first delay. The control part is configured to control the delay of the phase reference light of the delay interferometer by comparing the current monitored when the delay is the first delay and the corrected value of the current monitored when the delay is the second delay and maximizing or minimizing the current monitored by the monitor circuit.

### CROSS-REFERENCE TO RELATED APPLICATION

This application is a continuation application of PCT/JP2008/067498 filed Sep. 26, 2008, the contents of which are herein wholly incorporated by reference.

### FIELD

A certain aspect of the present invention is related to a phase modulated signal receiver that receives a phase modulated light signal.

### BACKGROUND

Recently, optical fiber communications that transfer information by not an electric signal but a light signal through a transmission line of an optical fiber have been developed and put in practical use in order to speed up networks and increase the capacities of the networks. In such optical fiber communications, in order to realize a further speedup and an increased capacity, it has been studied to increase the transmission capacity in a modulation using the phase of light.

An exemplary modulation method using the phase of light is differential phase shift keying (DPSK) or differential quadrature phase shift keying (DQPSK). A light signal modulated by any of these modulation methods is transmitted to a receiver through a transmission line such as an optical fiber. In the receiver, the original signal is demodulated from the light signal by a demodulator equipped with a delay interferometer (see Japanese Laid-Open Patent Application No. 2007-274235, Document 1).

### SUMMARY

According to an aspect of the present invention, there is provided a phase modulated signal receiver including: an interferometer configured to interfere a received light signal having a modulated phase with a phase reference light obtained by delaying the received light signal and to output an intensity modulated light signal that depends on a phase difference between the received light signal and the phase reference light; an opto-electric conversion element configured to convert the intensity modulated light signal to an electric signal; a monitor part configured to monitor a current that flows through the opto-electric conversion element; a measurement part configured to measure an input power of the received light signal on the basis of the current monitored by the monitor part; an operation part configured to correct, on the basis of a ratio of the input power measured by the measurement part when a delay of the phase reference light is a first delay and the input power when the delay of the phase reference light is a second delay, a value of the current monitored by the monitor part when the delay is the first delay to a corrected value of the current that depends on the input power of the received light signal obtained when the delay is the first delay; and a control part configured to control the delay of the phase reference light of the interferometer by comparing the value of the current monitored when the delay is the first delay and the corrected value of the current monitored when the delay is the second delay and maximizing or minimizing the current monitored by the monitor part.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram that illustrates configurations of a delay interferometer and a receiver;

FIG. 2 is a block diagram of a DPSK transmission system;

FIG. 3 is a block diagram of a demodulator and a phase adjustment circuit;

FIG. 4 is a diagram that illustrates results of a calculation of an average light-receiving current that flows through an opto-electric conversion element in relation to a phase error of the demodulator;

FIG. 5 is a diagram that illustrates a relation between the delay time of the demodulator and the average light-receiving current;

FIG. 6 is a diagram that illustrates a relation between the difference in the average light-receiving current and the phase error of the output signal of a delay interferometer;

FIG. 7 is a flowchart of a process in a case where average light-receiving currents of the normal phase and the inverse phase are monitored; and

FIG. 8 is a flowchart of a process in a case where the average light-receiving current of the inverse phase is monitored.

### DESCRIPTION OF EMBODIMENTS

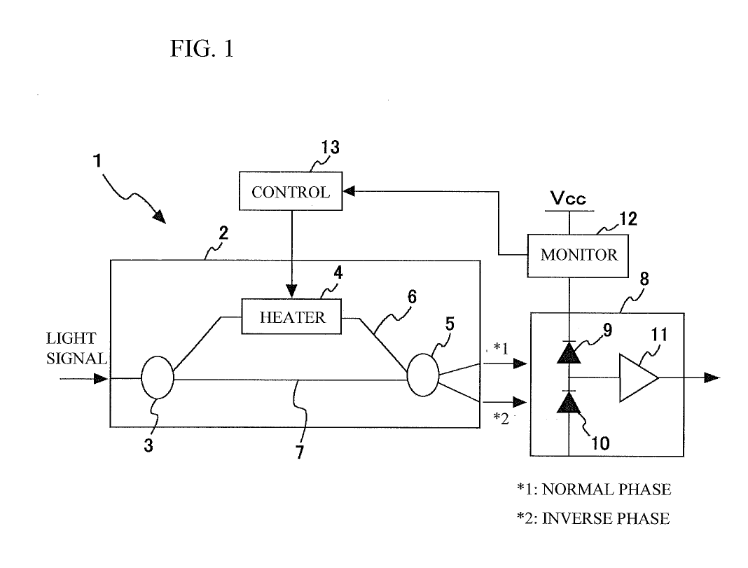

FIG. 1 illustrates a configuration of an optical receiver of the general phase modulation method. An optical receiver 1 is equipped with a delay interferometer 2, a receiver 8, a monitor circuit 12, and a control part 13. The delay interferometer 2 is equipped with photocouplers 3 and 5, and a heater 4. The receiver 8 is equipped with opto-electric conversion elements 9 and 10 and an amplifier 11. The light signal received is split into two signals by the photocoupler 3, one of which is transmitted through an optical fiber 6 and the other is transmitted through an optical fiber 7. The heater 4 is provided to the optical fiber 6. The heater 4 is controlled by the control part 13 so as to adjust the refractive index of the optical fiber 6 to make the difference in the optical length between the optical fiber 6 and the optical fiber 7 equal to a desired delay.

The light passing through the optical fiber and that passing through the optical fiber 7 are combined and interfered by the photocoupler 5. Thus, changes of the phases of the phase modulated light signals are converted to changes of the optical intensities, and two converted signals having a 180-degree (n) phase difference are output via two ports of the delay interferometer 2 of normal phase and inverse phase, respectively.

The opto-electric conversion elements 9 and 10 of the receiver 8 perform an opto-electric conversion process of converting the light signals having the converted optical intensities that are output via the two ports of the delay interferometer 2 to electric signals. The amplifier 11 amplifiers the electric signals output from the opto-electric conversion elements 9 and 10, and outputs amplified signals to a signal processing part (not illustrated) of a rear stage. The monitor circuit 12 monitors the average current (the average light-receiving current) supplied to the opto-electric conversion elements 9 and 10 from a power supply Vcc. The control part 13 controls the current that flows through the heater 4 on the basis of the average current of the opto-electric conversion elements 9 and 10 detected by the monitor circuit 12.

The control part 13 illustrated in FIG. 1 controls to make the average current of the opto-electric conversion elements 9 and 10 detected by the monitor circuit 12 equal to a target current while changing the current that flows through the heater 4. However, the interferometer 2 controls the optical length by the amount of heat of the heater 4. Since the response time of the heater 4 is long, it takes a long time to make the difference in the optical length between the optical fibers 6 and 7 equal to the desired difference. Thus, if the light signal has a power variation before and after the amount of heat of the heater 4 is changed, the average current of the opto-electric conversion elements 9 and 10 will change. Thus, the precision of controlling the delay of the delay interferometer 2 is degraded.

According to an aspect of an exemplary embodiment, there is provided a phase modulated signal receiver capable of more reliably controlling the delay of the delay interferometer involved in demodulation of the original signal from the received light signal having the modulated phase irrespective of a power variation of the received light signal.

A description will now be given, in conjunction with the accompanying drawings, of embodiments of the invention.

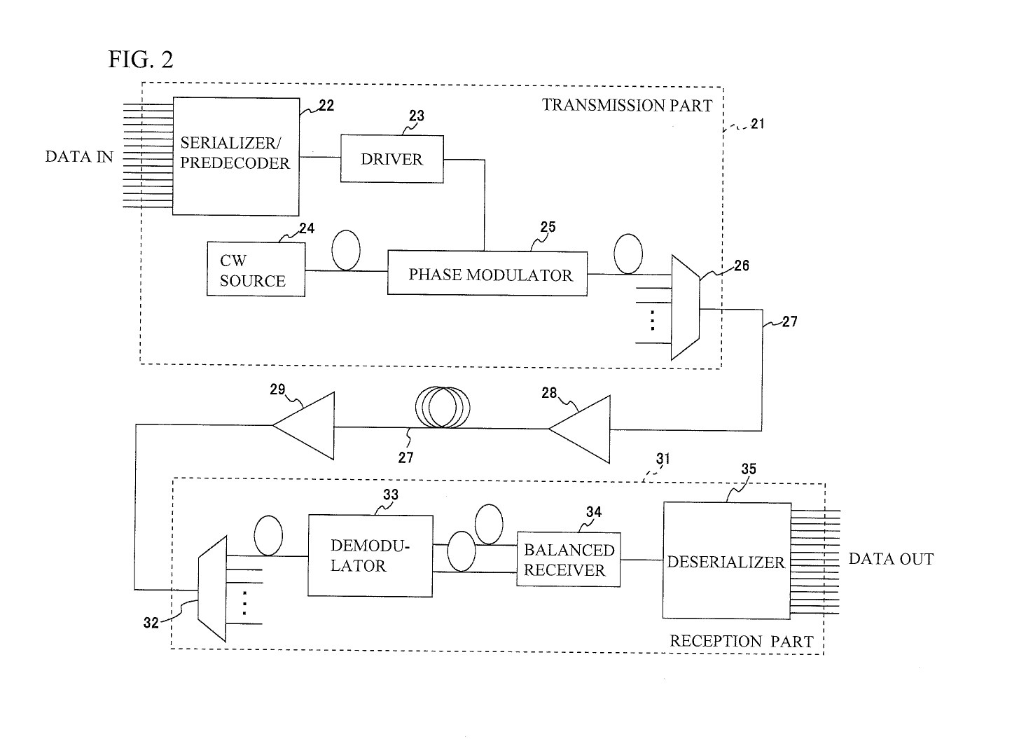

FIG. 2 is a diagram that illustrates a configuration of a DPSK in accordance with an embodiment. A transmission part 21 includes a serializer/predecoder 22, a driver 23, a CW (Continuous Wave) light source 24, a phase modulator 25, and a wavelength combiner 26.

The serializer/predecoder 22 converts parallel data to serial data, and outputs the serial data to the driver 23. The driver 23 outputs the serial data to the phase modulator 25. The phase modulator 25 DPSK-modulates the phase of the light signal from the CW light source 24 on the basis of the serial data, and outputs the light signal thus modulated to the wavelength combiner 26.

The wavelength combiner 26 combines a plurality of light signals having respective wavelengths with each other and applies a combined light signal to an optical transmission path 27. Amplifiers 28 and 29 for amplifying the light signal may be arranged on the optical transmission path 27. A reception part 31 includes a wavelength splitter 32, a demodulator 33, a balanced receiver 34, and a deserializer 35.

The wavelength splitter 32 splits the DPSK light signal having the multiplexed wavelengths into lights for every wavelength. For each wavelength, the demodulator 33 interferes the DPSK signal with a signal obtained by delaying the above DPSK light signal by about one bit (one symbol) of the transmission rate. When the DPSK light signal is in phase with the light signal that is one bit prior to the above DPSK light signal, the demodulator 33 outputs the interfered light signal to the output port of the normal phase. In contrast, when the phase of the DPSK signal is the inverse of the phase of the light signal that is one bit prior to the above DPSK signal, the demodulator 33 outputs the interfered light signal to the output port of the inverse phase.

For example, the balanced receiver 34 has two opto-electric conversion elements, and amplifies electric signals respectively derived from the opto-electric conversion elements. The deserializer 35 converts the output signal of the balanced receiver 34 to parallel data.

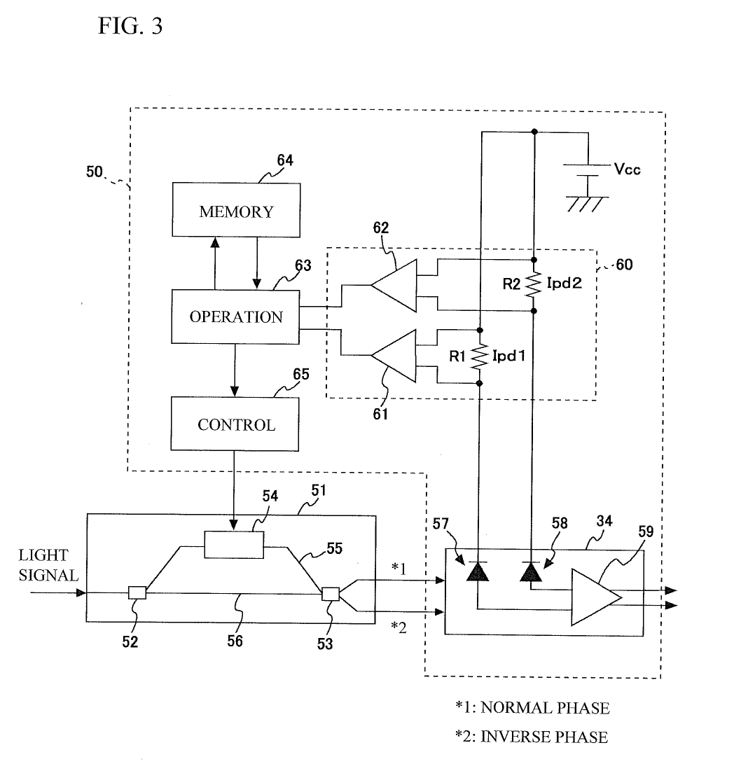

FIG. 3 is a diagram that illustrates configurations of the demodulator 33 and a phase adjustment circuit 50. FIG. 3 illustrates a case where a Mach-Zehnder type delay interferometer 51 is used as the demodulator 33 illustrated in FIG. 2.

The delay interferometer 51 has a photocoupler 52, two optical fibers 55 and 56, a heater 54 for phase adjustment, and a photocoupler 53. The incoming DPSK light signal is split into two lights by the photocoupler 52, one of which is transmitted through the optical fiber 56, and the other is transmitted through the optical fiber 55 having an optical length longer than that of the optical fiber 56. The phase adjustment heater 54 adjusts the refractive index of the optical fiber 55. The current that flows through the phase adjustment heater 54 is controlled by a control part 65 so that the difference in the effective optical length between the optical fiber 55 and the optical fiber 56 [(effective refractive index)×(difference in the physical fiber length)] becomes equal to a desired delay.

The delay interferometer 51 has two complementary output ports. The photocoupler 53 outputs the interfered light signal to the output port on the normal phase side as an intensity modulated signal when the DPSK light signal applied from the optical fiber 56 is in phase with the DPSK light signal that is one bit before. In contrast, the photocoupler 53 outputs the interfered light signal to the output port on the inverse phase side as an intensity modulated signal when the DPSK light signal applied from the optical fiber 56 is the inverse of the phase of the DPSK signal that is one bit before.

The phase adjustment circuit 50 is equipped with the balanced receiver 34, a monitor circuit 60, an operation part 63, a memory part 64 and the control part 65. The balanced receiver 34 has two opto-electric conversion elements 57 and 58, and an amplifier 59. The opto-electric conversion element 57, which is supplied with a bias current from the bias power supply Vcc, converts the intensity modulated signal having the normal phase that is output via the output port on the normal phase side to an electric signal. The opto-electric conversion element 58, which is supplied with a bias current from the bias power supply Vcc, converts the intensity modulated signal having the inverse phase that is output via the output port on the inverse phase side to an electric signal.

The monitor circuit 60 is a circuit that detects the average light-receiving currents respectively supplied to the opto-electric conversion elements 57 and 58 from the power supply Vcc (fixed potential part). As a part of the monitor circuit 60 involved in detection of the average light-receiving current supplied to the opto-electric conversion element 57, there are provided a resistor R1, and an amplifier 61 that amplifies the average light-receiving current detected by the resistor R1. As another part of the monitor circuit 60 involved in detection of the average light-receiving current supplied to the opto-electric conversion element 58, there are provided a resistor R2, and an amplifier 62 that amplifies the average light-receiving current detected by the resistor R2. The average light-receiving currents respectively detected by the amplifiers 61 and 62 are output to the operation part 63. Besides the configuration illustrated in FIG. 3, the monitor circuit 60 may be realized by a current detection circuit or a current transformer.

The operation part 63 adds the average light-receiving current Ipd1 detected by the resistor R1 of the monitor circuit 60 and the average light-receiving current Ipd2 detected by the resistor R2. Further, the operation part 63 subtracts the average light-receiving current Ipd2 from the average light-receiving current Ipd1. The operation part 63 saves, in the memory part 64, the average light-receiving currents Ipd1 and Ipd2 measured by the monitor circuit 60, as well as the adding operation result (Ipd1+Ipd2) and the subtracting operation result (Ipd1−Ipd2) calculated by the operation part 63.

The control part 65 controls the current that flows the heater 54 for phase adjustment on the basis of the results of the calculation by the operation part 63 so that the average light-receiving currents of the opto-electric conversion elements Ipd1 and Ipd2 detected by the monitor circuit 60 are maximized or minimized.

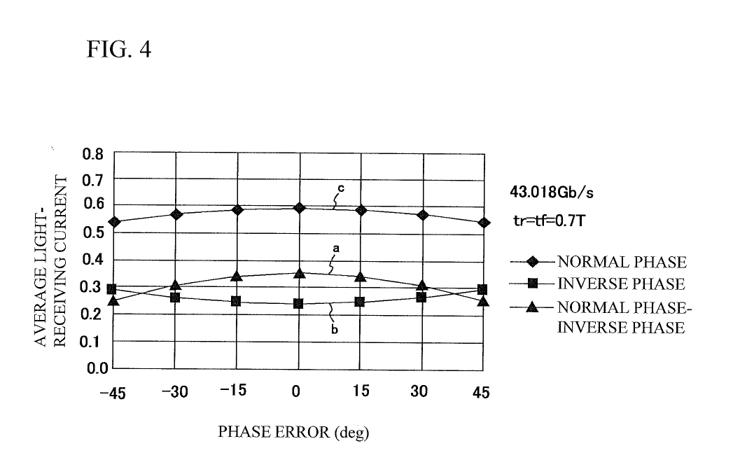

FIG. 4 illustrates the results of a calculation of the average current of the opto-electric conversion element 57 (or 58) in relation to a phase error of the demodulator 33. The inventors found out that there is a certain relation between the phase error of the phase modulated signal (DPSK modulated light signal) applied to the demodulator 33 and the average light-receiving current of the opto-electric conversion element 57 (or 58).

FIG. 4 illustrates an example of the results of calculation of the average current of the opto-electric conversion element 57 (or 58) in relation to the phase error of the demodulator 33 in a case where the rate of transmission of information is 43.018 Gb/s. The vertical axis of the graph of FIG. 4 indicates a relative value obtained by dividing the average light-receiving current of the opto-electric conversion element 57 (or 58) by the maximum amplitude value of the light-receiving current obtained when the demodulator has a delay of 1 bit. The horizontal axis of FIG. 4 indicates the phase error (deg).

Referring to FIG. 4, a line “a”, which connects triangular points, indicates the relative value of the difference between the average light-receiving current of the normal phase and the average light-receiving current of the inverse phase (this relative value is referred to as a difference in the average light-receiving current). A line b, which connects square points, indicates the relative value of the average light-receiving current of the inverse phase (this relative value is referred to as an average light-receiving current of the inverse phase). A line c, which connects rhombic points, indicates the relative value of the average light-receiving current of the normal phase (this relative value is referred to as an average light-receiving current of the normal phase).

It can be seen from FIG. 4 that the average light-receiving current of the normal phase is maximized when the phase error is the minimum (0 degree). The average light-receiving current of the inverse phase is minimized when the phase error is the minimum. The difference in the average light-receiving current between the normal phase and the inverse phase is maximized when the phase error is the minimum.

A description is now given of the reason why the phase error is minimized when the average light-receiving current that flows through the opto-electric conversion element is maximized or minimized. In the normal phase, as the phase error becomes greater, a transition-region waveform out of the waveform of the current that flows through the opto-electric conversion element 57 becomes closer to zero. Thus, the average of the whole waveform including the amplitude of the transition region waveform decreases. Therefore, the average light-receiving current of the normal phase that flows through the opto-electric conversion element 57 is maximized when the phase error is the smallest.

In the case of the inverse phase, its output has the complementary relation to the normal phase. Thus, as the phase error increases, the average value of the waveform part in the transition region of the current waveform that flows through the opto-electric conversion element 58 becomes greater. Thus, in the inverse phase, when the phase error is the smallest, the average light-receiving current of the opto-electric conversion element 42 is minimized.

It is thus possible to reduce the phase error of the phase modulated signal by monitoring the average light-receiving current that flows through the opto-electric conversion element 57 or 58 that receives the phase modulated signal of the normal phase or the inverse phase and controlling the delay of the demodulator 33 so that the average light-receiving current is maximized or minimized.

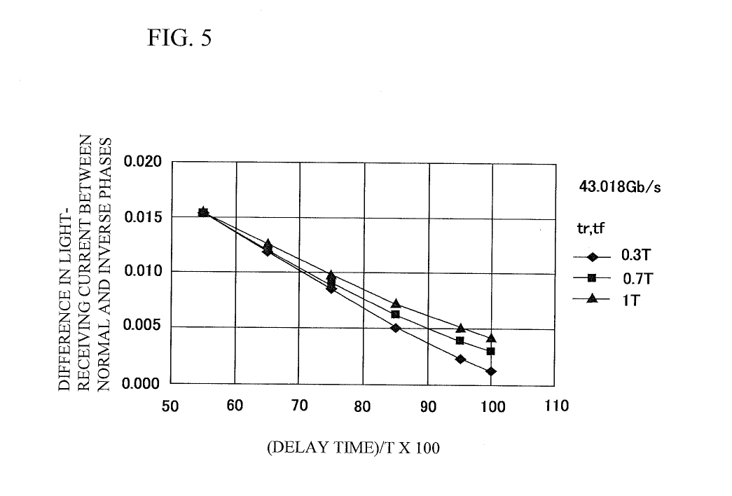

FIG. 5 is a graph that illustrates not only a relation between the difference in the average light-receiving current between the normal phase and the inverse phase for phase differences of 0 degree and 15 degrees and the delay time/T, but also a dependence of the rising and falling times of the modulated signal waveform. The vertical axis of FIG. 5 indicates the difference in the average light-receiving current between the normal phase and the inverse phase, and the horizontal axis thereof indicates the percentage of the delay time of the demodulator 33 with respect to the time T of one bit.

In FIG. 5, triangular points indicate the difference in the average current between the normal phase and the inverse phase in a case where the rising time tr of the waveform of the DPSK modulated light signal and the falling time tf thereof are equal to the time T of one bit of the transmission rate.

Square points indicate the difference in the average current between the normal phase and the inverse phase in a case where the rising time tr and the falling time tr are 70% of the time T of one bit of the transmission rate. Rhombic points indicate the difference in the average current between the normal phase and the inverse phase in a case where the rising time tr and the falling time tf are 30% of the time T of one bi of the transmission rate.

It is seen from FIG. 5 that the difference in the average light-receiving current between the normal phase and the inverse phase becomes greater as the rising time tr and the falling time tf of the waveform of the DPSK modulated light signal are more gentle. Further, the difference in the average light-receiving current between the normal phase and the inverse phase becomes greater as the delay time of the demodulator 33 is shorter than the time T of one bit of the transmission rate. This characteristic holds true for the average light-receiving current of the normal phase and that of the inverse phase.

The correlation between the delay time and the difference in the average light-receiving current is due to the fact that the waveform in the transition region (more specifically, the rising and falling regions of the waveform) when the phase error is small is eccentrically located to the maximum value of the amplitude in the normal phase and to the zero level in the inverse phase, and increases a variation in the average caused by the phase error.

The correlation between the rising and falling times of the waveform of the phase modulated light signal and the difference in the average light-receiving current is due to the fact that as the rising and falling times of the waveform become longer, the time of the transition regions having components that vary the average becomes longer, and the average (average light-receiving current) caused by the phase error has an increased variation.

As described above, the phase error of the phase modulated signal may be reduced by monitoring the average light-receiving current Ipd1 or Ipd2 that flows through the opto-electric conversion element 57 or 58, and controlling the delay of the demodulator 33 so that the average light-receiving current is maximized or minimized. It is also possible to reduce the phase error of the phase modulated signal by monitoring the average light-receiving currents Ipd1 and Ipd2 that flow through the opto-electric conversion elements 57 and 58, respectively, and controlling the delay of the demodulator 33 so that the difference between these average light-receiving currents is maximized or minimized.

However, in the case where the optical length is controlled by the heat generated by the phase adjustment heater 54 in order to control the delay of the demodulator 33, the response time of the heater 54 is very long. Thus, it takes a long time for the amount of heat of the phase adjustment heater 54 to actually reach the target amount of heat after the control of changing the amount of heat generated by the heater 54 is started in order to change the optical length. In a case where the received light signal has a power variation before and after the amount of heat of the phase adjustment heater 54 is changed, there is a problem that the average light-receiving currents Ipd1 and Ipd2 of the opto-electric conversion elements 57 and 58 change and the precision of controlling the delay of the delay interferometer 51 is thus degraded.

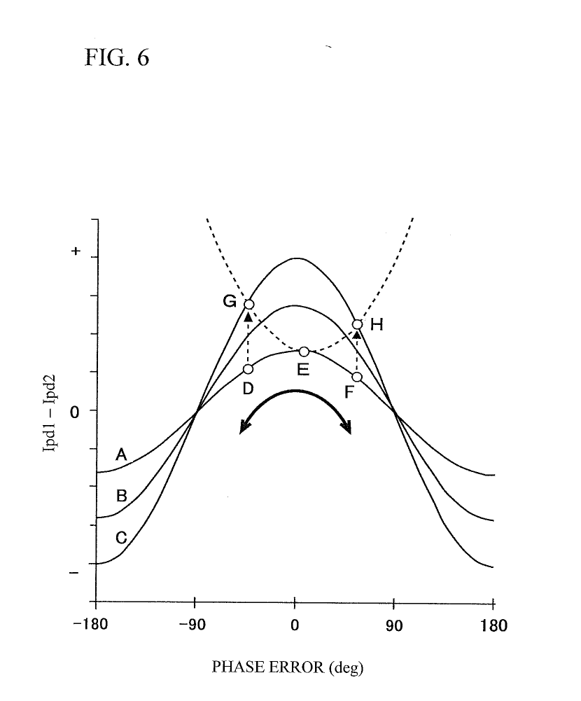

A further description will now be given with reference to FIG. 6. The vertical axis of FIG. 6 indicates the difference in the average light-receiving current between the opto-electric conversion elements 57 and 58 (Ipd1−Ipd2). The horizontal axis of FIG. 6 indicates the phase error (deg) of the phase modulated signal. For example, a solid line A in FIG. 6 is a curve that indicates the difference in the average light-receiving current (Ipd1−Ipd2) in a case where there is no variation in the input power of the light signal. In a case where there is no variation in the input power of the light signal, the difference in the average light-receiving current (Ipd1−Ipd2) (for example, circular symbols D, E and F on the solid line A) is detected by adjusting the amount of heat generated by the phase adjustment heater 54.

It is assumed that, while the amount of heat of the phase adjustment heater 54 is being adjusted, the input power of the light signal varies as illustrated in a solid line B or C in FIG. 6. The input power of the light signal has a proportional relation to the output of the normal phase and that of the inverse phase of the delay interferometer 51. Thus, as the input power of the light signal varies, the difference in the average light-receiving current (Ipd1−Ipd2) varies. Thus, although the point D on the solid line A should be detected originally, a point G on the solid line C in FIG. 6 is erroneously detected as the difference in the average light-receiving current (Ipd1−Ipd2). Similarly, although a point F on the solid line A should be detected originally, a point H on the solid line C in FIG. 6 is erroneously detected. As a result of erroneous detection, the control process may recognize that a dotted curve is involved in the current processing and may misunderstand the maximum as the minimum.

With the above in mind, the present embodiment monitors the average light-receiving currents that respectively flow through the opto-electric conversion elements 57 and 58 when the heater voltage is V0 by the monitor circuit 60, and calculates the sum of the monitored currents by the operation unit 63. Since the input power of the light signal has the proportional relation to the normal-phase and inverse-phase outputs of the delay interferometer 51, the sum of the average light-receiving currents (Ipd1+Ipd2) is obtained as a quantity proportional to the input power of the light signal. The sum of the average light-receiving currents (Ipd1+Ipd2) obtained by the operation part 63 is saved in the memory part 64.

Next, the heater voltage is changed to V1, and the operation part 63 calculates the sum of the average light-receiving currents (Ipd1′+Ipd2′) that respectively flow through the opto-electric conversion elements 57 and 58 when the heater voltage is V1. Then, the operation part 63 calculates the ratio of the sum of the average light-receiving currents for the heater voltage V1 and the sum of the average light-receiving currents for the heater voltage V0 (the above ratio is hereinafter referred to as ΔPow).

$$\begin{matrix}Δ Pow = ( sum of the average light \text{-} receiving currents for V 1 ) / \\ ( sum of the average light \text{-} receiving currents for V 0 ) ) \\ = ( Ipd {1}^{′} + Ipd {2}^{′} ) / ( Ipd 1 + Ipd 2 )\end{matrix} \qquad ( 1 )$$

The above ΔPow describes the ratio of the input power of the light signal for the heater voltage V1 and that for the heater voltage V0.

Then, the operation part 63 multiplies the monitored current for the heater voltage V1 by ΔPow. It is thus possible to correct the monitored currents for the heater voltage V1 to the values depending on the input power of the light signal for the heater voltage V0. It is thus possible to compare the monitored currents for the heater voltage V0 and those for the heater voltage V1 without any influence of variation in the input power of the light signal.

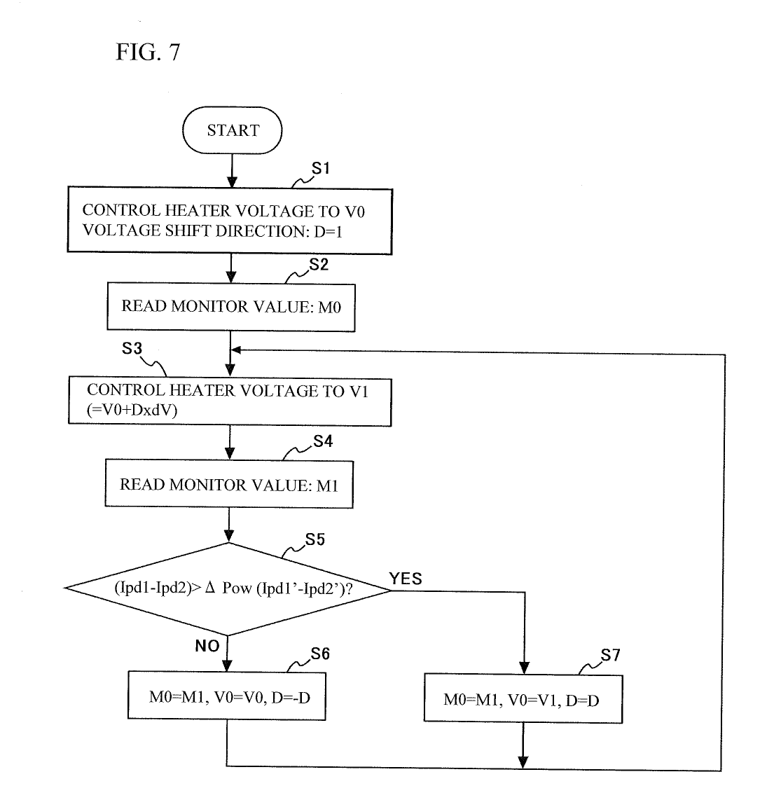

A description will be given of processing operations of the control part 65 and the operation part 63 so as to control the current that flows through the phase adjustment heater 54 in conjunction with a flowchart of FIG. 7. First, the control part 65 sets V0 as the initial value of the output voltage V (step S1), and sets “1” that specifies, as direction data D that specifies a voltage shift direction, the increasing direction. In the present embodiment, the control part 65 varies the output voltage in order to change the current that flows through the phase adjustment heater 54.

Next, the operation part 63 reads a monitored value M0 (Ipd1, Ipd2) of the monitor circuit 60, which includes the average light-receiving currents of the normal phase and the inverse phase when the output voltage V is equal to V0 (step S2). Then, the operation part 63 obtains the output voltage V1 by adding D×dV. The control part 65 supplies the output voltage V1 thus obtained to the phase adjustment heater 54 (step S3). The process of step S3 includes a process of adding or subtracting a positive or negative constant value dV to or from the current value of the output voltage V in order to increase or decrease the output voltage V.

Next, the operation part 63 reads, from the monitor circuit 60, the average light-receiving currents M1 (Ipd1 Ipd2′) of the normal phase and the inverse phase for the output voltage V1 that has been increased or decreased (step S4). Then, the operation part 63 calculates the ratio ΔPow of the sum of the average light-receiving currents (Ipd1+Ipd2) of the normal phase and the inverse phase when the output voltage V is equal to V0 and the sum of the average light-receiving currents (Ipd1′+Ipd2′) of the normal phase and the inverse phase when the output voltage V is equal to V1.

$$\begin{matrix}Δ Pow = ( sum of the average light \text{-} receiving currents for V 1 ) / \\ ( sum of the average light \text{-} receiving currents for V 0 ) ) \\ = ( Ipd {1}^{′} + Ipd {2}^{′} ) / ( Ipd 1 + Ipd 2 )\end{matrix} \qquad ( 1 )$$

Next, the operation part 63 calculates the difference in the average light-receiving current between the normal phase and the inverse phase (Ipd1′−Ipd2′) when the output voltage V is equal to V1, and multiplies the difference by the ΔPow obtained above. Then, the operation part 63 compares the multiplied (corrected) value ΔPow(Ipd1′−Ipd2′) with the previous difference (Ipd1−Ipd2) in the average light-receiving current between the normal phase and the inverse phase (step S5). When (Ipd1−Ipd2)>ΔPow(Ipd1′−Ipd2′) (step S5/NO), the control part 65 determines that the control has passed the maximum value. Therefore, the control part 65 changes the direction data D that indicates the voltage shift direction to “−D” and returns the heater voltage to V0 (step S6). Thus, in a case where the direction is controlled to increase the output voltage (the direction of increasing the delay of the demodulator 33) till that time, the direction of controlling is switched to decrease the output voltage. Alternatively, in a case where the direction is controlled to decrease the output voltage till that time, the direction of controlling is switched to increase the output voltage. Further, the operation part 63 saves the monitored value M1 (Ipd1′ and Ipd2′) for the output voltage V1 in the memory part 64 as M0 in order to use M1 as the previous value in the next-time monitor (step S6).

When (Ipd1−Ipd2)<ΔPow(Ipd1′−Ipd2′) (step S5/YES), the control part 65 determines that the control has not passed the maximum value. Thus, the control part 65 maintains the direction data D that indicates the voltage shifting direction in “D”, and controls the heater voltage to V1 (step S7). Further, the operation part 63 saves the monitored value M1 (Ipd1′ and Ipd2′) for the output voltage V1 in the memory part 64 as M0 in order to use M1 as the previous value in the next-time monitor (step S7).

According to the above-described process, it is possible to control the delay of the demodulator 33 so that the difference in the average light-receiving current between the normal phase and the inverse phase is close to the maximum value even if the input power of the received light signal varies. It is thus possible to reduce the error in controlling the delay of the delay interferometer involved in demodulation for the phase modulated signal.

It is to be noted that the above-described process may be applied to a case where the delay is controlled so that the average light-receiving current of the normal phase is close to the maximum value.

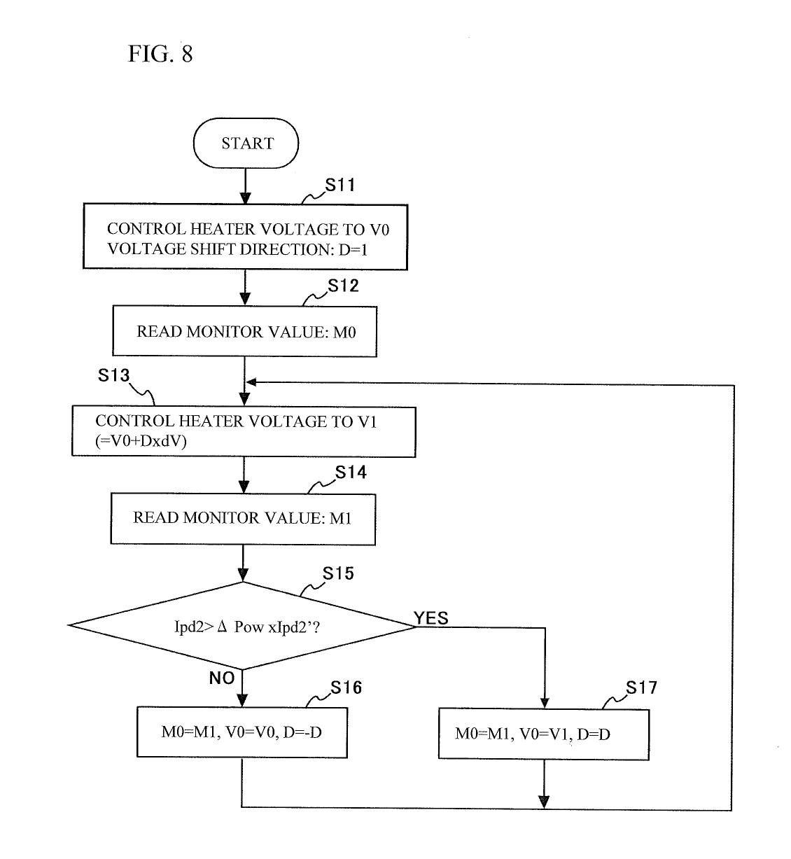

FIG. 8 is a flowchart of processes and operations of the operation part 63 and the control part 65 in a case where the average light-receiving current of the inverse phase is monitored.

The operation part 63 sets V0 as the initial value of the output voltage, and sets the direction data D that indicates the voltage shift direction to “1” that indicates voltage increasing. The control part 65 varies the output voltage in order to control the current supplied to the phase adjustment heater 54 (step S11).

Next, the operation part 63 reads the monitor value M0 (Ipd1, Ipd2) of the monitor circuit 60 that monitors the average light-receiving currents of the normal phase and the inverse phase when the output voltage V is equal to V0 (step S12). Then, the operation part 63 obtains the output voltage V1 by adding D×dV to the voltage V, and the control part 65 supplies the output voltage V1 thus obtained to the phase adjustment heater 54 (step S13). The process of step S13 is directed to increasing or decreasing the output voltage by adding the value obtained by multiplying the constant value dV by the direction data D to the output voltage V0.

The operation part 63 reads the monitored value M1 (Ipd1′, Ipd2′) for the updated output voltage V1 from the monitor circuit 60 (step S14). Then, the operation part 63 calculates the ratio ΔPow of the sum of the average light-receiving currents (Ipd1+Ipd2) of the normal phase and the inverse phase when the output voltage V is equal to V0 and the sum of the average light-receiving currents (Ipd1′+Ipd2′) of the normal phase and the inverse phase when the output voltage V is equal to V1. The ratio ΔPow may be obtained by using the aforementioned expression (1).

Next, the operation part 63 multiplies the average light-receiving current Ipd2′ of the inverse phase when the output voltage V is equal to V1 by ΔPow obtained above. Then, the operation part 63 compares the multiplied value (ΔPow×Ipd2′) with the previous average light-receiving current Ipd2 of the inverse phase (step S15). When Ipd2<(ΔPow×Ipd2′) (step S15/NO), the control part 65 determines that the control has passed the minimum value. Thus, the control part 65 changes the direction data D that indicates the voltage shift direction to “−D”, and returns the heater voltage to V0 (step S16). Thus, in a case where the direction is controlled to increase the output voltage (the direction of increasing the delay of the demodulator 33) till that time, the direction of controlling is switched to decrease the output voltage. Alternatively, in a case where the direction is controlled to decrease the output voltage till that time, the direction of controlling is switched to increase the output voltage. Further, the operation part 63 saves the monitored value M1 (Ipd1′ and Ipd2′) for the output voltage V1 in the memory part 64 as M0 in order to use M1 as the previous value in the next-time monitor (step S16).

When Ipd2>(ΔPow×Ipd2′) (step S15/YES), the control part 65 determines that the control has not passed the minimum value. Thus, the control part 65 maintains the direction data D that indicates the voltage sift direction in “D”, and controls the heater voltage to V1 (step S17). Further, the operation part 63 saves the monitored value M1 (Ipd1′ and Ipd2′) for the output voltage V1 in the memory part 64 as M0 in order to use M1 as the previous value in the next-time monitor (step S17).

According to the above-described process, it is possible to control the delay of the demodulator 33 so that the difference in the average light-receiving current between the normal phase and the inverse phase is close to the minimum value even if the input power of the received light signal varies. It is thus possible to reduce the error in controlling the delay of the delay interferometer for demodulation of the phase modulated signal.

The above-described embodiments are preferred embodiments of the present invention. The present invention is not limited to these embodiments, but may include various embodiments and variations without departing from the scope of the present invention.

For example, the delay may be controlled in such a manner that a signal of a low frequency f0 is imposed on the signal that controls the delay of the delay interferometer 51, and the frequency component of the frequency 10 of the average light-receiving current or the frequency 210 is maximized or minimized. For example, in the flowcharts of FIGS. 7 and 8, D×dV used to obtain the output voltage V1 from the output voltage V0 may not be constant.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A phase modulated signal receiver comprising:
an interferometer configured to interfere a received light signal having a modulated phase with a phase reference light obtained by delaying the received light signal and to output an intensity modulated light signal that depends on a phase difference between the received light signal and the phase reference light;
an opto-electric conversion element configured to convert the intensity modulated light signal to an electric signal;
a monitor part configured to monitor a current that flows through the opto-electric conversion element;
a measurement part configured to measure an input power of the received light signal on the basis of the current monitored by the monitor part;
an operation part configured to correct, on the basis of a ratio of the input power measured by the measurement part when a delay of the phase reference light is a first delay and the input power when the delay of the phase reference light is a second delay, a value of the current monitored by the monitor part when the delay is the first delay to a corrected value of the current that depends on the input power of the received light signal obtained when the delay is the first delay; and
a control part configured to control the delay of the phase reference light of the interferometer by comparing the value of the current monitored when the delay is the first delay and the corrected value of the current monitored when the delay is the second delay and maximizing or minimizing the current monitored by the monitor part.

2. The phase modulated signal receiver according to claim 1, wherein:
the opto-electric conversion element receives the intensity modulated light signal of a normal phase output from the interferometer;
the monitor part monitors an average light-receiving current of the normal phase; and
the control part controls the delay of the phase reference light of the interferometer by comparing the average light-receiving current monitored when the delay is the first delay and a corrected value of the average light-receiving current monitored when the delay is the second delay and maximizing the average light-receiving current monitored by the monitor part.

3. The phase modulated signal receiver according to claim 1, wherein:
the opto-electric conversion element receives the intensity modulated light signal of an inverse phase output from the interferometer;
the monitor part monitors an average light-receiving current of the inverse phase; and
the control part controls the delay of the phase reference light of the interferometer by comparing the average light-receiving current monitored when the delay is the first delay and a corrected value of the average light-receiving current monitored when the delay is the second delay and minimizing the average light-receiving current monitored by the monitor part.

4. The phase modulated signal receiver according to claim 1, wherein:
the opto-electric conversion element includes a first opto-electric conversion element that receives the intensity modulated light signal of a normal phase output from the interferometer, and a second opto-electric conversion element that receives the intensity modulated light signal of an inverse phase;
the monitor part includes a first monitor part that monitors an average light-receiving current of the normal phase, and a second monitor part that monitors an average light-receiving current of the inverse phase; and
the control part controls the delay of the phase reference light of the interferometer by comparing a difference between the average light-receiving current of the normal phase monitored by the first monitor part when the delay is the first delay and the average light-receiving current of the inverse phase monitored by the second monitor part when the delay is the second delay with a difference between a corrected value of the average light-receiving current monitored by the first monitor part when the delay is the second delay and a corrected value of the average light-receiving current of the inverse phase monitored by the second monitor part when the delay is the second delay and maximizing a difference between the average light-receiving current of the normal phase monitored by the first monitor part and the average light-receiving current of the inverse phase monitored by the second monitor part.

5. The phase modulated signal receiver according to claim 1, wherein:
the opto-electric conversion element includes a first opto-electric conversion element that receives the intensity modulated light signal of a normal phase output from the interferometer, and a second opto-electric conversion element that receives the intensity modulated light signal of an inverse phase;
the monitor part includes a first monitor part that monitors an average light-receiving current of the normal phase, and a second monitor part that monitors an average light-receiving current of the inverse phase; and
the measurement part measures a sum of the current monitored by the first monitor part and the current monitored by the second monitor part as the input power of the received light signal.
